(19) United States
(12) Patent Application Publication
(10) Pub. No.: US 2024/0399370 A1
(43) Pub. Date: Dec. 5, 2024

(54) FLUID PROCESSING DEVICE FOR MANIPULATING AND PROCESSING DROPLETS

(71) Applicant: IMEC VZW, Leuven (BE)

(72) Inventors: Elisabeth Marchal, Blanden (BE); Rocco Stirparo, Leuven (BE); Ying Ting Set, Heverlee (BE); Abdulkadir Yurt, Heverlee (BE)

(21) Appl. No.: 18/680,062

(22) Filed: May 31, 2024

(30) Foreign Application Priority Data
Jun. 1, 2023 (EP) 23176639.5

(51) Int. Cl. B01L 3/00

(52) U.S. Cl. CPC B01L 3/502784; B01L 2200/10; B01L 2300/18; B01L 2400/043

(57) ABSTRACT

The present disclosure provides devices for manipulating droplets of a fluid by electrowetting. The disclosure provides a fluid processing device comprising a first plate-like structure and a second plate-like structure, which are configured to manipulate one or more droplets located between the first and the second plate-like structure by electrowetting. The fluid processing device comprises a plurality of functional zones, and each functional zone comprises at least two of a first sub-zone for applying heat to the one or more droplets, a second sub-zone for applying a magnetic field to the one or more droplets, and a third sub-zone for providing light onto and/or detecting light emitted by the one or more droplets.

### CROSS-REFERENCE TO RELATED APPLICATIONS

The present application is a non-provisional patent application claiming priority to European Patent Application No. EP 23176639.5, filed on Jun. 1, 2023, the contents of which are hereby incorporated by reference.

### FIELD OF THE DISCLOSURE

The present disclosure relates to devices for manipulating one or more droplets of a fluid or liquid by electrowetting. The present disclosure also provides a device which is adapted to perform one or more processing operations on the one or more droplets. These processing operations comprise a treatment of the one or more droplets by heat, light, and/or magnetic field. The droplet processing may be used for implementing a workflow, for instance, a sample library preparation workflow.

### BACKGROUND

Library preparation of samples is an important step for next generation sequencing. The process of library preparation may entail an adaptation of the samples so that they are compatible with downstream sequencing chemistry. Library preparation protocols usually consist of many steps of processing the sample, which require expensive reagents and significant hands-on-time.

Different types of sequencing chemistries have allowed a diversification in research questions that can be addressed by next generation sequencing, and have also diversified the possibilities in sample input and library preparation protocols. As a consequence, however, genomic core facilities need to constantly optimize existing workflows, and are under pressure to handle diverse requests from different customers. Library preparation is becoming the bottleneck of sequencing workflows, and by extension of the next generation sequencing ecosystem. Under current methods, the library preparation may account for up to 50% of the sequencing lead times.

In an example of an automated library preparation which may be implemented in core facilities, multiple samples are processed in batches. Certain instruments used for the processing are run when the core facility receives a sufficient number of samples. In this way, the instruments (e.g., pipetting robots) may be run in a cost-effective manner. As a consequence, however, on-demand sample processing or different library preparation workflows is typically not supported. In addition, the batching of the samples lengthens the processing lead times.

### SUMMARY

The present disclosure provides methods, devices, and systems for manipulating and processing droplets.

Conventional electrowetting devices, like electrowetting on dielectric (EWOD) devices, can be used to manipulate one or more droplets, e.g., comprising samples. Further, the electrowetting devices may be equipped with fixed magnetic, thermal, and fluorescence detection zones, which may be implemented at the instrument level. Thus, the electrowetting devices could be used for an automated library preparation. However, at any one time, each zone can support processing of the droplets with only one set of operating parameters (e.g., one fixed temperature). As a consequence, only one workflow at a time can effectively be implemented using the electrowetting device.

In view of the above, the present disclosure provides a device for implementing the automated manipulation and processing of one or more droplets. The present disclosure also allows for the implementation of automated library preparation workflows with the device. For example, some example embodiments enable customized and on-demand processing of droplets comprising samples, and different kinds of sample library preparation workflows. Other example embodiments enable the simultaneous implementation of the workflows, which may be initiated at different times.

These are achieved by the methods, devices, and systems described in the independent claims. Further implementations are further described in the dependent claims.

A first aspect of the present disclosure provides a fluid processing device comprising: a first plate-like structure and a second plate-like structure configured to manipulate one or more droplets, which are located between the first and the second plate-like structure, by electrowetting, wherein the fluid processing device comprises a plurality of functional zones, and each functional zone comprises at least two of: a first sub-zone for applying heat to the one or more droplets; second sub-zone for applying a magnetic field to the one or more droplets; and a third sub-zone for providing light onto and/or detecting light emitted by the one or more droplets.

The fluid processing device of the first aspect is able to process the one or more droplets of a fluid or liquid, and further can apply different processing operations to the one or more droplets. These operations comprise a treatment of the one or more droplets by heat, light, and/or magnetic field, and/or comprise optical measurements of the one or more droplets. Notably, the fluid may be a sample or may include a sample, for example, a droplet may comprise at least one sample. In this case, the fluid processing device may process the droplets for the purpose of implementing a sample library preparation workflow. A sample may be an analyte sample (e.g., blood), or may also include other chemical fluids (e.g., reagents), which may be captured in the droplet(s).

Due to the plurality of functional zones, and particularly the two or more sub-zones of each functional zone, the fluid processing device of the first aspect may implement customized and on-demand processing of the one or more droplets. Thus, the device may implement different kinds of library preparation workflows. For example, the device may simultaneously implement different kinds of workflows, wherein these workflows may be initiated at the same time or at different times. The at least two sub-zones of each functional zone may, in order to achieve an efficient droplet processing, be addressable individually (e.g., via an active selection matrix bitline and wordline layer).

A sub-zone can include two functions. For instance, a first sub-zone or a second sub-zone can be configured to provide both heat and magnetic field.

Any plate-like structure of the fluid processing device may be a substrate or may comprise a substrate, wherein one or more functional elements for respectively providing heat, and/or a magnetic field, and/or light, may be integrated into the substrate. The substrate may comprise multiple layers which are used to embed and structure these integrated functional elements, for instance, by means of forming metal layers, depositing oxides, forming dielectric layers, or similar processing operations of an integrated process flow.

Any plate-like structure of the fluid processing device may also be a glass sheet or may comprise a glass sheet, or may be or comprise a similar transparent element, on or besides which one or more external functional elements for respectively providing the heat, and/or the magnetic field, and/or the light, may be arranged or attached.

Together, the first plate-like structure and the second plate-like structure of the fluid processing device may form a fluidic chamber for guiding, holding, and/or manipulating the one or more droplets.

Manipulating the one or more droplets by electrowetting may comprise at least one of the following: moving the one or more droplets within a functional zone (e.g., from one sub-zone to another sub-zone of the functional zone); moving the one or more droplets into or out of a functional zone (e.g., from or to another functional zone); splitting at least one of the one or more droplets (e.g., in more smaller droplets); and combining or mixing two or more droplets (e.g., into a larger droplet). Notably, the terms “fluid” and “liquid” may be used interchangeably in this disclosure. The fluid/liquid may be water, or a water-chemistry-mix, or a suitable carrier liquid for samples, or may be a sample like blood.

The reliability of manipulating the one or more droplets by electrowetting—also referred to as electrowetting actuation or droplet actuation—may be improved by employing an electrical and/or optical sensing mechanism. For example, a particular sub-zone of any functional zone of the fluid-processing device may be allocated to the sensing mechanism, wherein a droplet state of a droplet can be sensed and detected with the sensing mechanism in the particular sub-zone. The droplet state can, for instance, simply be the presence or absence of the droplet in the functional zone, particularly, in the particular sub-zone. A network of sensors could be used to estimate a droplet volume, a droplet shape, etc. The sensing mechanism can be carried out via resistance, capacitance, or optical density measurements, as an example.

Accordingly, in an example embodiment of the fluid processing device, one or more functional zones of the fluid processing device respectively comprise a sensing sub-zone for sensing a droplet state of at least one droplet.

In another example embodiment of the fluid processing device, each sensing sub-zone comprises one or more sensors configured to detect the droplet state. The one or more sensors may comprise electrical sensors and/or optical sensors.

In another example embodiment of the fluid processing device, each sub-zone has an area in a range of 1e⁻⁶ cm² to 1 cm², or in a range of 5e⁻⁵ cm² to 5e⁻⁴ cm².

The sub-zones can thus be small, for example, can be smaller than, or in an example embodiment at least ten times smaller than, the size of a typical droplet, in order to be small enough to process single droplets. The functional zones, which comprise such small sub-zones, may be individual pixels of a (bio) chip comprising multiple pixels.

In an implementation of the fluid processing device, the functional zones are identical.

For instance, the size of all of the functional zones may be identical. Moreover, in any functional zone of the fluid processing device, the size of all the sub-zones of this functional zone and/or the arrangement of the sub-zones may be identical. Thus, the fluid processing device may comprise a repeating pattern of functional zones and sub-zones.

In another example embodiment of the fluid processing device, a pattern of the functional zones is identical but may be reversely arranged in at least two functional zones. In another implementation of the fluid processing device, the functional zones are distinct from each other, or at least two functional zones may be distinct from each other.

In another example embodiment of the fluid processing device, in the second sub-zone, a metal coil is embedded in the first plate-like structure or in the second plate-like structure, the metal coil being configured to generate a magnetic field.

Embedding the metal coil in such a manner is referred to as an “in-cell configuration” of the second sub-zone, as no external magnetic field generating element is required. This may allow for the magnetic field to be generated near to the one or more droplets than with an external magnetic field generating element.

In another example embodiment of the fluid processing device, in the first sub-zone, a micro-heater is embedded in the first plate-like structure or in the second plate-like structure.

Embedding the micro-heater in such a manner is referred to as an “in-cell configuration” of the first sub-zone, as no external heating element is required. Embedding functional elements into one or both plate-like structures allows making the fluid processing device more compact, and facilitates its integration into a chip or into an array of fluid processing devices.

In the above example embodiments, if the fluid processing device has a first zone and a second zone, the magnetic coil and the micro-heater may be embedded in the same plate-like structure (i.e., they may be arranged on the same side) or may be embedded in different plate-like structures (i.e., they may be arranged on opposite sides). In addition, more than one metal coil and/or more than one micro-heater may be, respectively, embedded into the first plate-like structure or into the second plate-like structure, or into both plate-like structures.

In an example embodiment of the fluid processing device: in the second sub-zone, one or more magnetic field generating elements are respectively arranged on or besides an outer surface of the first plate-like structure or of the second plate-like structure; and/or in the first sub-zone, one or more heating elements are respectively arranged on or besides the outer surface of the first plate-like structure or of the second plate-like structure.

This example embodiment is referred to as an “add-on configuration” of the first sub-zone and/or second sub-zone, as external functional elements may be used. The magnetic field generating elements and the heating elements may be arranged on the same side of the two plate-like structures, or may be arranged on opposite sides of the two plate-like structures.

In another example embodiment of the fluid processing device, in the third sub-zone, a light emitting device and a photodetector are respectively embedded in the first plate-like structure or in the second plate-like structure.

Embedding these optical elements in such a manner is referred to as an “in-cell configuration” of the third sub-zone. The light emitting device (e.g., a light emitting diode) and the photodetector (e.g., a CMOS sensor) may be embedded in the same plate-like structure or in different plate-like structures. The light emitting device may be configured to emit light of at least one wavelength, and the photodetector may detect light in at least that at least one wavelength and optionally other wavelengths.

In another example embodiment of the fluid processing device, in the third sub-zone: the first plate-like structure and/or the second plate-like structure is transparent to light of at least one predetermined wavelength; and a light emitting device, which is configured to emit the light of the at least one predetermined wavelength, and a photodetector are respectively arranged on or besides an outer surface of the first plate-like structure or of the second plate-like structure.

This example embodiment is referred to as an “add-on configuration” of the third sub-zone, as external functional elements may be use.

In another example embodiment of the fluid processing device, at least one of the first sub-zone, the second sub-zone, and the third sub-zone is implemented in the in-cell configuration. In another example embodiment of the fluid processing device, at least two of the first sub-zone, the second sub-zone, and the third sub-zone are implemented in the in-cell configuration. In these example embodiments, the sub-zones that are not implemented in the in-cell configuration may be implemented in the add-on configuration. The in-cell configuration allows for implementations with no external components and a more compact design. In another example embodiment of the fluid processing device, all three sub-zones may be implemented either in the in-cell configuration or in the add-on configuration.

In an example embodiment of the fluid processing device, at least one of the functional zones comprises the first sub-zone, the second sub-zone, and the third sub-zone, and comprises a fourth sub-zone, which is identical to either the first sub-zone, the second sub-zone, or the third sub-zone.

For instance, a combination of two first sub-zones, one second sub-zone, and one third sub-zone is possible. Another example is to combine one first sub-zone, two second sub-zones, and one third sub-zone into the functional zone.

In an example embodiment, the fluid processing device further comprises one or more magnets arranged next to the first plate-like structure and/or the second plate-like structure, wherein the one or more magnets are configured to generate a magnetic field that penetrates the one or more droplets when they are located between the first and the second plate-like structure.

Each magnet may be a permanent magnet. A magnet may be implemented by a magnetic layer. Multiple magnets may be arranged next to at least one the first plate-like structure and the second plate-like structure. The one or more magnets may be located on any one side of the two plate-like structures, or on both sides. The one or more magnets may be located above or beneath the two plate-like structures, respectively.

Notably, “next to” in this respect may mean that the one or more magnets are arranged directly next to the first and/or second plate-like structure, for instance, adjacent to the first and/or the second plate-like structure. This may maximize the magnetic field induced forces. However, “next to” may also mean that the one or more magnets are not arranged directly next to the first and/or second plate-like structure, but at least in a certain proximity to the first and/or second plate-like structure that allows the magnetic field to penetrate the one or more droplets when they are located between the first and the second plate-like structure. For instance, “next to” may mean at a distance to the first and/or the second plate-like structure that is less than a few centimeters, for example, less than 10 cm, or less than 5 cm, or less than 2 cm. The one or more magnets may also be movable relative to the first and the second plate-like structure, for instance by means of a mechanical actuation mechanism, so that they can be brought to be arranged “next to” the first and/or second plate-like structure on demand.

In an example embodiment, the fluid processing device further comprises a thermal interface arranged next to the first plate-like structure and/or the second plate-like structure, wherein the thermal interface is configured to provide a predetermined temperature across at least the first plate-like structure and the second plate-like structure.

The “next to” in this respect, i.e. related to the thermal interface, is interpreted in the same way as the “next to” related to the one or more magnets described above.

The thermal interface is thus configured to provide the predetermined temperature across droplets located between the plate-like structures. The thermal interface may be implemented as a layer. A thermal interface layer and a magnetic layer forming the magnet may be arranged one on the other next to the first and/or second plate-like structure. The thermal interface may be configured to generate heat or cooling itself, or may be provided with thermal energy to further distribute the heat or cooling.

In an example embodiment, the fluid processing device further comprises a heat pump configured to provide a thermal energy transfer from the thermal interface or to the thermal interface.

The heat pump may transfer the thermal energy to or from a heat sink or a heat source, or the like. The heat pump can thus be thermally connected to the thermal interface.

In an example embodiment, the fluid processing device further comprises a thermal controller configured to control the thermal interface and/or the heat pump.

For instance, the thermal interface may be controlled by the thermal controller to change temperature. As another example, a heat energy transfer of the heat pump may be increased or decreased by the thermal controller

In an example embodiment, the fluid processing device further comprises: one or more input ports, each input port being configured to receive the one or more droplets and to provide the one or more droplets to between the first plate-like structure and the second plate-like structure; and/or one or more output ports, each output port being configured to eject the one or more droplets from between the first plate-like structure and the second plate-like structure or from the fluid processing device.

In an example embodiment of the fluid processing device, the one or more input ports and/or the one or more output ports comprise respectively one or more piezoelectric micromachined ultrasonic transducers (PMUTs).

In another example embodiment, the fluid processing device comprises or is integrated with a fluidic distribution network.

The fluidic distribution network may (fluidically) link the one or more input ports and the one or more output ports of the fluid processing device, respectively, to an external fluidic interface. The fluidic interface may be accessible, for example, via pipettes. The fluidic distribution network may be a part of the fluid processing device, or may be external the fluid processing device.

The fluidic distribution network may allow connecting one external facing port to one or more input ports of the fluid processing device in a controlled way. For instance, in a controlled way may mean that a pressure and/or a volume quantity of fluid over the connection is measurable and adjustable. This can be used when a reagent or a sample material needs to be metered and distributed to multiple locations on the fluid processing device, for instance to perform parallel operations. The fluidic distribution network may be realized by or in plastic, glass, or another material, and may contain at least one of: a fluidic channel, a fluidic chamber, a valve, and another component to enable fluid transfer.

In another example embodiment, the fluid processing device comprises an EWOD device, and/or comprises an array of thin film transistors for applying droplet electrowetting.

In another example embodiment, the fluid processing device further comprises or is connected to controller circuitry, which is configured to control the fluid processing device.

The fluid-processing device may be controlled by the controller circuitry to perform predefined operations. One or more predefined operations, or respective instructions for performing the predefined operations, may be stored in a local memory of the fluid processing device, or in an external memory. For example, the controller circuitry may control the fluid processing device to combine different functional zones and/or sub-zones, for example, in dependence of a reagent or a sample volume of the current workflow. The controller circuitry may also interact with a sensor or a sensor network of the fluid processing device, in order to adapt the operations of the fluid processing device in the presence of, for example, local failures of zones and/or sub-zones. For instance, the controller circuitry may control the fluid processing device to divert operations to respectively other zones and/or sub-zones. This may be done, for example, if a local failure is detected.

In an example embodiment, the fluid processing device further comprises one or more programmable separators, which are configured to separate the plurality of functional zones into a plurality of regions, wherein each region comprises at least one functional zone.

The one or more separators may thus be configured to split the area of the device that comprises the functional zones into multiple regions. These regions are local regions, which are physically separated from each other by the respective separator(s). This separation may prevent material interchange in the form of droplet transport or diffusion via a medium. The one or more separators may be further helpful to minimize or eliminate potential cross-contamination between different samples or workflows running (e.g. in parallel) in different regions of the fluid processing device. Each separator may be implemented by a phase change material, which may be transported as droplets or pre-printed on any plate-like structure in the liquid phase. A reversible or non-reversible phase change may be induced via heat activation, or by a chemical reaction between multiple materials, so as to induce solidification and a barrier (separator) formation between different regions of the fluid processing device. This may be done on demand and flexibly as desired.

A second aspect of the present disclosure provides a fluid processing array comprising a plurality of fluid processing devices according to the first aspect or any implementation thereof.

The fluid processing array may specifically be a sample processing array configured to perform a sample processing workflow. The fluid processing array may be used for (sample) library preparation, and could be included in a cartridge for library preparation.

In an example embodiment of the fluid processing array, the fluid processing array is a chip or a panel; or the fluid processing array comprises a plurality of chips, each chip comprising at least one of the fluid processing devices.

Any chip may be a bio chip, and may comprise multiple unit cells or pixels, which may correspond to the multiple functional zones of a fluid processing device. A panel may be a planar arrangement of multiple such chips or fluid processing devices.

A third aspect of the present disclosure provides fluid processing system comprising at least one fluid processing device according to the first aspect or any implementation thereof, or comprising the fluid processing array of the second aspect or any implementation thereof, wherein the fluid processing system further comprises a control unit configured to address and control individually each sub-zone of each functional zone in the fluid processing system.

The fluid processing system may be a sample processing system configured to perform a sample processing workflow, for example, a sample library preparation workflow.

Since each sub-zone in the fluid processing system is individually addressable, a variety of such workflows can be performed on the one or more droplets, wherein each workflow may include multiple processing operations.

The control unit may be or may comprise the above-mentioned controller circuitry.

In an example embodiment of the fluid processing system, the control unit is configured to: control an operation of one or more sub-zones of any functional zone of the fluid processing device or of the fluid processing array, so as to apply heat, a magnetic field, and/or light, in any order, to one or more droplets; and/or control at the same time an operation of any two or more functional zones of the fluid processing device or of the fluid processing array, so as to respectively apply heat, a magnetic field and/or light, in any order, to one or more first droplets and to one or more second droplets.

In this way, different library preparation workflows can be implemented subsequently or simultaneously with high efficiency.

In an example embodiment of the fluid processing system, the control unit is further configured to: control a movement of one or more droplets to one or more functional zones of the fluid processing device or of the fluid processing array; and/or control a movement of one or more droplets to one or more fluid processing devices of the fluid processing system.

A fourth aspect of the present disclosure provides a computer program comprising instructions which, when the program is executed by the control unit (e.g., a processor therefor), causes the fluid processing system to perform the above actions, or to perform the method of the fifth aspect, or to implement a droplet processing workflow.

A fifth aspect of the present disclosure provides a method for fluid processing, the method comprising: manipulating one or more droplets arranged between a first plate-like structure and a second plate-like structure by electrowetting; and applying, by respectively operating one or more sub-zones of a plurality of functional zones of the pair of plate-like structures, at least two of heat, a magnetic field, and light, in any order, to the one or more droplets.

The method of the fifth aspect may be extended by respective implementations as described above for the fluid processing device of the first aspect.

### BRIEF DESCRIPTION OF THE DRAWINGS

The above, as well as additional features will be better understood through the following illustrative and non-limiting detailed description, with reference to the appended drawings. In the drawings, like reference numerals will be sued for like elements unless stated otherwise.

FIG. 1 shows a fluid processing device, according to an example embodiment.

FIG. 2(a) shows one configuration of a fluid processing device, according to an example embodiment.

FIG. 2(b) shows another configuration of a fluid processing device, according to an example embodiment.

FIG. 3(a) shows one configuration of the structure of a fluid processing device, wherein the two plate-like structures comprise surface coating layers, according to an example embodiment.

FIG. 3(b) shows another configuration of the structure of a fluid processing device, wherein the two plate-like structures comprise surface coating layers, according to an example embodiment.

FIG. 4 shows an example of a plate-like structure with embedded functional elements for a fluid processing device, according to an example embodiment.

FIG. 5 shows an example of a plate-like structure with embedded functional elements and with magnetic and/or thermal elements for a fluid processing device, according to an example embodiment.

FIG. 6(a) shows an in-cell configuration of a third sub-zone of a fluid processing device, according to an example embodiment.

FIG. 6(b) shows another in-cell configuration of a third sub-zone of a fluid processing device, according to an example embodiment.

FIG. 7(a) shows an add-on configuration of a third sub-zone of a fluid processing device, according to an example embodiment.

FIG. 7(b) shows another add-on configuration of a third sub-zone of a fluid processing device, according to an example embodiment.

FIG. 8(a) shows an add-on configuration of first and/or second sub-zones of a fluid processing device, according to an example embodiment.

FIG. 8(b) shows another add-on configuration of first and/or second sub-zones of a fluid processing device, according to an example embodiment.

FIG. 9(a) shows a part of a fluid processing array and a fluid processing device which may be used for implementing atypical or longer processing workflows, according to an example embodiment.

FIG. 9(b) shows another part of a fluid processing array and a fluid processing device which may be used for implementing atypical or longer processing workflows, according to an example embodiment.

FIG. 9(c) shows another part of a fluid processing array and a fluid processing device which may be used for implementing atypical or longer processing workflows, according to an example embodiment.

FIG. 9(d) shows another part of a fluid processing array and a fluid processing device which may be used for implementing atypical or longer processing workflows, according to an example embodiment.

FIG. 10(a) shows a functional zone of a fluid processing device, wherein the functional zone is designed without a third sub-zone, according to an example embodiment.

FIG. 10(b) is an expanded view of a portion of the functional zone shown in FIG. 10(a), according to an example embodiment.

FIG. 11(a) shows an implementation for individually addressing sub-zones in a fluid processing system, according to an example embodiment.

FIG. 11(b) is a view of a sub-zone in a fluid processing system, according to an example embodiment.

FIG. 12 shows a method for processing a fluid, according to an example embodiment.

### DETAILED DESCRIPTION

Reference will now be made in detail to the embodiments of the present disclosure, examples of which are illustrated in the accompanying drawings. However, the following embodiments of the present disclosure may be variously modified and the range of the present disclosure is not limited by the following embodiments.

Directional terminology such as top, bottom, front, back, leading, trailing, under, over and the like in the description and the claims is used for descriptive purposes with reference to the orientation of the drawings being described, and not necessarily for describing relative positions. Because components of example embodiments can be positioned in a number of different orientations, the directional terminology is used for purposes of illustration only, and is in no way intended to be limiting, unless otherwise indicated. It is, hence, to be understood that the terms so used are interchangeable under appropriate circumstances and that the example embodiments described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices comprising only components A and B.

Reference throughout this specification to “one embodiment” or “an embodiment” means that a particular feature, structure or characteristic described in connection with the embodiment is included in at least one example embodiment. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the description of example embodiments, various features are sometimes grouped together in a single embodiment, figure, or description thereof for the purpose of streamlining the disclosure and aiding in the understanding of one or more of the various aspects of the disclosure. This method of disclosure, however, is not to be interpreted as reflecting an intention that the example embodiment requires more features than are expressly recited in each claim. Rather, as the following claims reflect, aspects of the claims lie in less than all features of a single foregoing disclosed embodiment. Thus, the claims following the detailed description are hereby expressly incorporated into this detailed description, with each claim standing on its own as a separate example embodiment.

Furthermore, while some embodiments described herein include some but not other features included in other embodiments, combinations of features of different embodiments are meant to be within the scope of the disclosure, and form different embodiments, as would be understood by those in the art.

In the description provided herein, numerous specific details are set forth. However, it is understood that example embodiments may be practiced without these specific details. In other instances, well-known methods, structures and techniques have not been shown in detail in order not to obscure an understanding of this description.

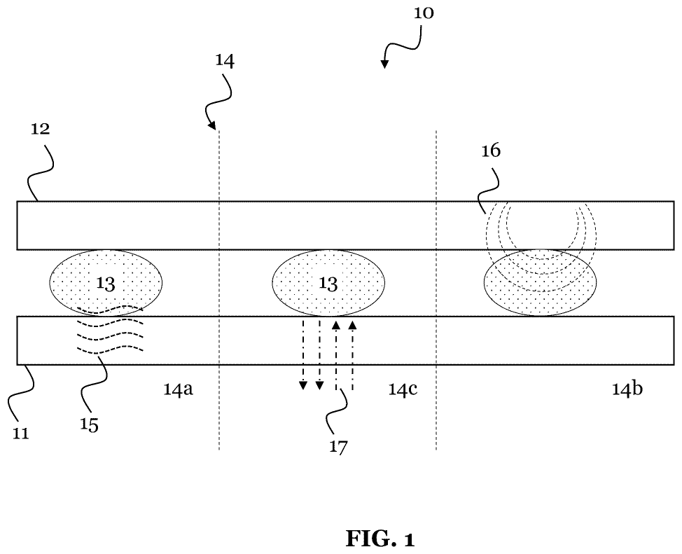

FIG. 1 shows a fluid processing device 10 according to the present disclosure. The fluid processing device 10 is configured to manipulate and process one or more droplets 13 of a fluid or liquid. The fluid or liquid processing device 10 may be a sample processing device, and the fluid or liquid may accordingly comprise one or more samples, for example, each droplet may comprise at least one sample. A sample may be an analyte sample (e.g., blood or other bodily fluid), or may be any other chemical fluid (e.g., a reagent), which may be captured in the droplet. The droplets may be of a fluid or liquid suitable for containing the one or more samples

The fluid processing device 10 comprises a first plate-like structure 11 and a second plate-like structure 12 which are configured to receive the one or more droplets 13 in the space between the plate-like structures, and to hold or guide the droplets 13 in between the plate-like structures. The plate-like structures 11 and 12 are also configured to manipulate the one or more droplets 13 when the droplets 13 are located between the plate-like structures 11 and 12. Manipulating the one or more droplets 13 may comprise moving the one or more droplets 13, and/or splitting one or more droplets 13, and/or combining one or more droplets 13. In some example embodiments, the plate-like structures 11 and 12 are configured to manipulate the one or more droplets 13 by electrowetting. The plate-like structures 11 and 12 may, for example, be parts of an EWOD device. The two plate-like structures 11 and 12 may together form or be part of a fluidic chamber that has two surfaces, wherein the one or more droplets 13 are arranged, held and/or guided between the two surfaces, i.e., both surfaces may touch the one or more droplets 13. At least one of the plate-like structures 11, 12 may be a TFT backplane (e.g., for EWOD), and may comprise an array of two or more TFTs.

The fluid processing device 10 comprises a plurality of functional zones 14, wherein different regions of the pair of plate-like structures 11 and 12 may provide these functional zones 14. Each functional zone 14 may be configured to perform at least two functions or processing operations on the one or more droplets 13. Each functional zone 14 has multiple sub-zones, wherein each sub-zone may be used for one of the processing operations. The functional zones 14 of the fluid processing device 10 may all be identical. For instance, each functional zone 14 may have the same size, and/or may have the same number of sub-zones, and/or may have the same types of sub-zones, and/or may have the same layout or arrangement of sub-zones

In some example embodiments, each functional zone 14 comprises at least two of a first sub-zone 14a, a second sub-zone 14b and a third sub-zone 14c (shown exemplarily in FIG. 1, not necessarily belonging to the same functional zone 14). Each of these sub-zones 14a, 14b, and 14c may have an area in a range of 1e⁻⁶ cm² to 1 cm², for example, an area in a range of 5e⁻⁵ cm² to 5e⁻⁴ cm². The first sub-zone 14a may apply heat 15 to the one or more droplets 13, and may thus be referred to as a “heat sub-zone”. The second sub-zone 14b may apply a magnetic field 16 to the one or more droplets 13, and may thus be referred to as a “magnetic sub-zone” The third sub-zone 14c may provide light 17 onto the one or more droplets 13, and/or may detect light 17 emitted by the one or more droplets 13, and may thus be referred to as a “light sub-zone”

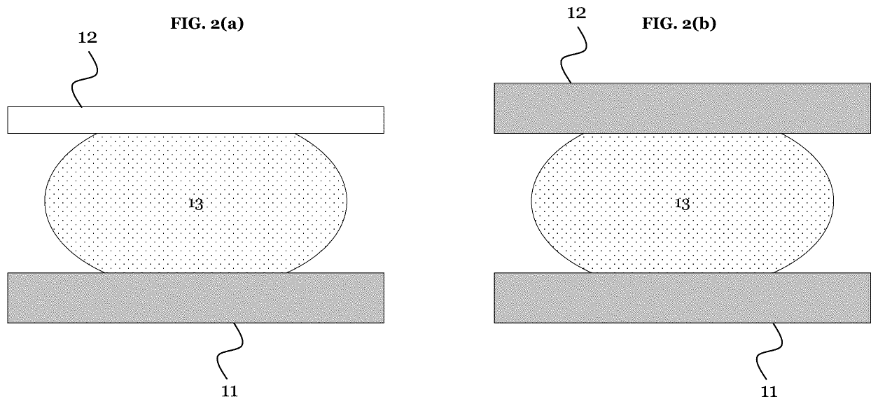

FIG. 2(a) and FIG. 2(b) show schematically different examples of configurations of the fluid processing device 10 and the pair of plate-like structures 11 and 12. These configurations are respectively shown in cross-sectional views of the fluid processing device 10 in FIG. 2(a) and FIG. 2(b).

FIG. 2(a) shows a first configuration of the fluid processing device 10. In this first configuration, the first plate-like structure 11 is configured to perform the functions or processing operations, i.e., for applying at least two of the heat 15, the magnetic field 16, and the light 17, to the one or more droplets 13 (and/or to detect the light 17 emitted from the droplets 13). The second plate-like structure 12 is non-functional in this first configuration, for instance, it may be a transparent sheet. In an example embodiment, the second plate-like structure 12 may be made of glass, and may be coated with a transparent oxide. The first plate-like structure 12 may be a TFT backplane with integrated circuits and/or integrated functional elements. The first configuration may be referred to as “single TFT backplane configuration”.

FIG. 2(b) shows a second configuration. In this second configuration, both the first plate-like structure 11 and the second plate-like structure 12 are configured to perform the functions or processing operations, i.e., for applying the at least two of heat 15, magnetic field 16, and light 17, to the one or more droplets 13 (and/or to detect the light 17 emitted from the droplets 13). In some example embodiments, both the first and the second plate-like structure 11, 12 may be a TFT backplane with integrated circuits and/or integrated functional elements. The second configuration may be referred to as “double TFT backplane configuration.

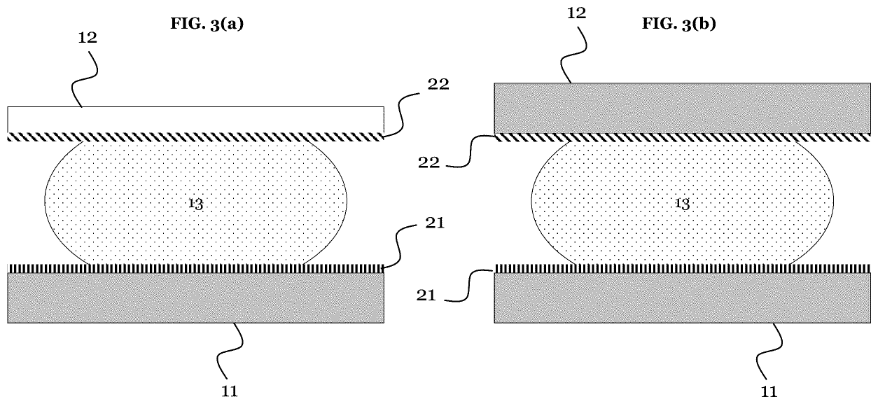

FIG. 3(a) and FIG. 3(b) show schematically different examples of configurations of the fluid processing device 10 and the pair of plate-like structures 11 and 12. These configurations are respectively shown in cross-sectional views of the fluid processing device 10 in FIG. 3(a) and FIG. 3(b). The configurations in FIG. 3 may be similar or identical as those shown in FIG. 2.

FIGS. 3(a) and 3(b) also shows that the surface properties of the respective surfaces of the plate-like structures 11 and 12 may be modified and/or tailored. For example, the surface of any one or of both the plate-like structures 11 and 12 can be coated, for instance, with surface coating layers that facilitate a reliable operation and reuse of the fluid processing device 10. These additional coating(s) may be in the form of polymer or organic surfaces, and can, for example, prevent surface fouling, electrostatic charging, and dielectric breakdown of the underlying layers.

FIGS. 3(a) and 3(b) shows particularly a first coating layer 21 arranged on the first plate-like structure 11 (on its inner surface towards the droplet(s) 13) and a second coating layer 22 on the second plate-like structure 12 (also on its inner surface). These coating layers 21 and 22 may be both applied, or may be applied individually. The first coating layer 21 may be different from the second coating layer 22, however, the coating layers 21 and 22 may also be the same. Each coating layer 21 and 22 may be or comprise a polymer layer and/or an organic layer. The coating layers 21 and 22 may respectively be used in all the implementations of the plate-like structures 11 and 12 of the fluid-processing device 10 discussed in this disclosure.

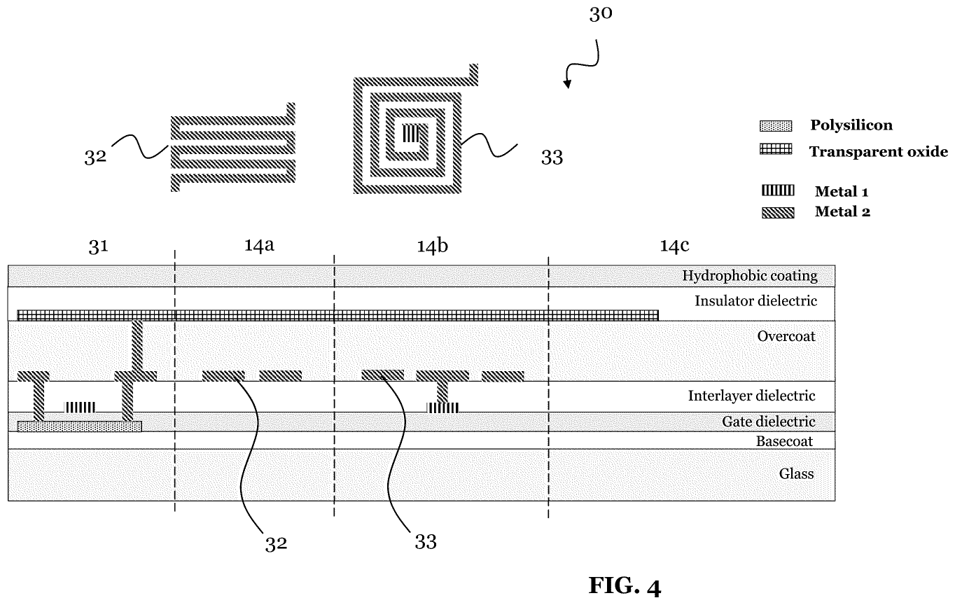

FIG. 4 shows a cross-sectional view of a functional plate-like structure 30, according to an example embodiment. The functional plate-like structure 30 may be used in the fluid processing device 10 of FIG. 1, for instance, and/or in any configuration shown in FIGS. 2(a) and (b) or FIGS. 3(a) and 3(b). The plate-like structure 30 may be the first plate-like structure 11 or the second plate-like structure 12 of the fluid processing device 10, or both. The plate-like structure 30 may be a TFT backplane. The plate-like structure 30 may comprise a substrate, which may include a plurality of layers. An example of the layers as shown includes: a glass layer; a base coating layer arranged on the glass layer; a gate dielectric layer arranged on the base coating layer; an interlayer dielectric arranged on the gate dielectric layer; an overcoat layer arranged on the interlayer dielectric; an insulator dielectric arranged on the overcoat layer; and a hydrophobic coating arranged on the insulator dielectric. The substrate may be similar to a substrate used in a EWOD device, and is thus configured to manipulate the one or more droplets 13, which touch the hydrophobic coating surface, by electrowetting.

In addition, the substrate may be provided with integrated circuits and/or functional elements. For example, the functional plate-like structure 30 shown in FIG. 4 comprises the first sub-zone 14a, the second sub-zone 14b, and the third sub-zone 14c. In the first sub-zone 14a, a micro-heater 32 is embedded into the plate-like structure 30, for example, formed by a metal layer in the overcoat layer. The micro-heater 32 is configured to generate the heat 15, which is then experienced by the one or more droplets 13 on the surface of the plate-like structure 30. In the second sub-zone 14c, a metal coil 33 is embedded in the plate-like structure 30, for example, formed by two metal layers in the overcoat layer and the interlayer dielectric, respectively. The metal coil 33 is configured to generate the magnetic field 16, which is then experienced by the one or more droplets 13 on the surface of the plate-like structure 30. A transparent oxide may be arranged above the micro-heater 32 and the metal coil 33, respectively. Since the micro-heater 32 and the metal coil 33 are respectively embedded functional elements, the first sub-zone 14a and the second sub-zone 14b are provided in the so-called in-cell configuration.

In the third sub-zone 14c, the functional plate-like structure 30 is transparent to light of at least one predetermined wavelength. Thus, for example, a light emitting device configured to emit the light of the at least one predetermined wavelength may be arranged on or besides an outer surface of the plate-like structure 30 (e.g., besides or on the glass layer), and may emit light through the plate-like structure 30 onto the one or more droplets 13 and/or may detect light emitted by the one or more droplets 13 through the plate-like structure 30. Since the light emitting device would in this case be external of the plate-like structure 30, the third sub-zone 14c is in this case provided in the so-called add-on configuration.

The functional plate-like structure 30 shown in FIG. 4 may further comprise a region 31, in which one or more TFT circuits may be embedded, wherein these circuits are configured for individually addressing and operating the functional sub-zones 14a, 14b, and 14c. The circuits may be formed by one or more metal layers and polysilicon layers, which are embedded and structured in the substrate layers, e.g., as illustrated.

As described above, FIG. 4 shows a possible cross-section of a functional part of the fluid processing device 10 and illustrates a build—in of different functional elements into the plate-like structure 30. These functional elements may include transparent EWOD electrodes, e.g., made of indium tin oxide (ITO) for performing droplet manipulation. Further, these functional elements may include the micro-heater structures 32, may include the magnetic metal coil structures 33, and may include see-through sub-zones (e.g., ITO). The sub-zones 14a, 14b, 14c may be unit cells or pixels of a chip.

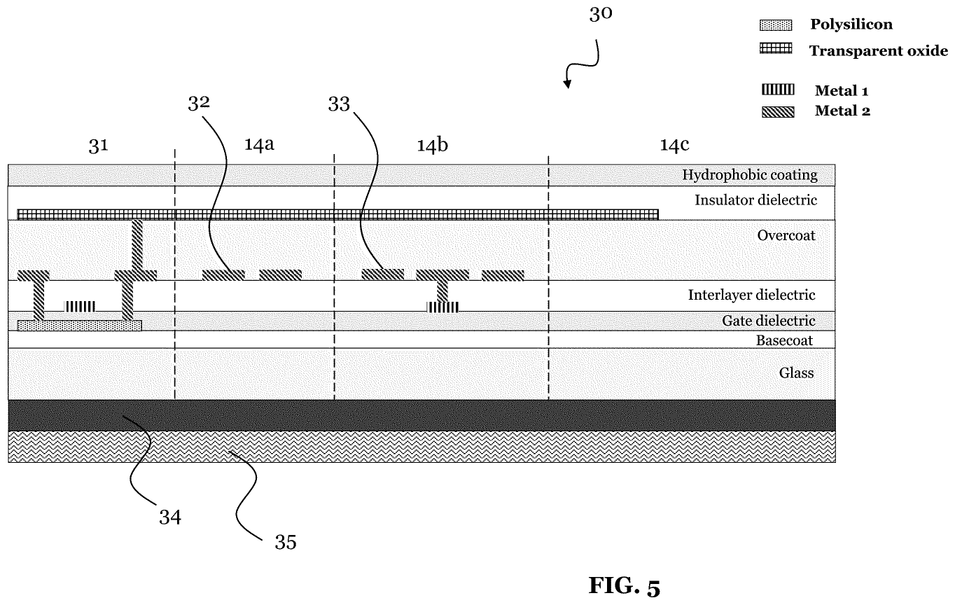

FIG. 5 shows a cross-sectional view of another functional plate-like structure 30, according to an example embodiment. The functional plate-like structure 30 may be used in the fluid processing device 10 of FIG. 1, for instance, and/or in any configuration shown in FIGS. 2(a) and 2(b) or FIGS. 3(a) and 3(b). The plate-like structure 30 may be the first plate-like structure 11 or the second plate-like structure 12 of the fluid processing device 10, or both. The plate-like structure 30 may be a TFT backplane.

The plate-like structure 30 shown in FIG. 5 is based on the plate-like structure 30 shown in FIG. 4. The two plate-like structures 30 shown in FIG. 5 and FIG. 4 may be identical except that the plate-like structure 30 shown in FIG. 5 may comprise further components such as at least one of a magnet 34 and a thermal interface 35.

The magnet 34 may be a permanent magnet, which may be implemented by a layer made of a magnetic material, which may be arranged adjacent to the substrate layers and adjacent to the glass layer. The magnet 34 may increase magnetic forces in the fluid processing device 10. Magnetic force is proportional to the product of the magnetic field gradient and its magnitude. The magnetic force generated by the local magnetic elements, for example the coils 33, in the second sub-zone(s) 14b for applying the magnetic field 16 to the one or more droplets 13, can be increased by the presence of a global magnetic field provided by the magnet 34. The magnet 34 may be placed within the proximity of the second sub-zone(s) 14b so as to create a magnetic field across the fluid processing device 10, wherein the magnetic field penetrates through at least the droplets 13 arranged in the second sub-zone(s) 14b. Instead of the single magnet 34 shown in FIG. 5, also a collection of multiple magnets can be used. These may be placed around the fluid processing device 10 to create a magnetic field. In some example embodiments, the magnetic field may be larger than 100 G. The magnetic field provided by the magnet 34 (or the collection of multiple magnets) extends and covers the sub-zones 14b, in which the droplets 13 can be actuated by the magnetic elements, for instance, the coils 33.

The thermal interface 35 may be controlled by a thermal controller. The thermal interface 35 may help to improve the performance of the fluid processing device 10 by providing a global thermal control across the fluid processing device 10. In some example embodiments the thermal controller may maintain a global temperature within a temperature range of 4-60° C. The global thermal control may allow for the temperature of the fluid processing device 10 or the droplet temperature to be kept at a predetermined value. The predetermined value may, for example, be defined by the assay, the workflow, or the device characteristics. The global thermal control may be used to facilitate certain conditions. For example, some reagents can be kept at a low temperature for use. In some example embodiments, it is also possible that the fluid processing device 10 creates undesired heat due to current applied to its functional element, and thus the overall temperature of the fluid processing device 10 may increase during its operation beyond the safe limits of the assay. The global thermal control can be achieved using the thermal interface 35 on at least one of the substrate surfaces, which is not in contact with the droplets 13. This thermal interface 35 may be thermally linked to a heat pump configured to provide heat energy transfer to or from the fluid processing device 10, so as to achieve the target value of the temperature. The heat may be controlled by the thermal controller. The global thermal control may be further be optimized by using a single or a plurality of temperature sensors on the substrate, or in the vicinity of the substrate, so as to create a feedback loop for the thermal controller.

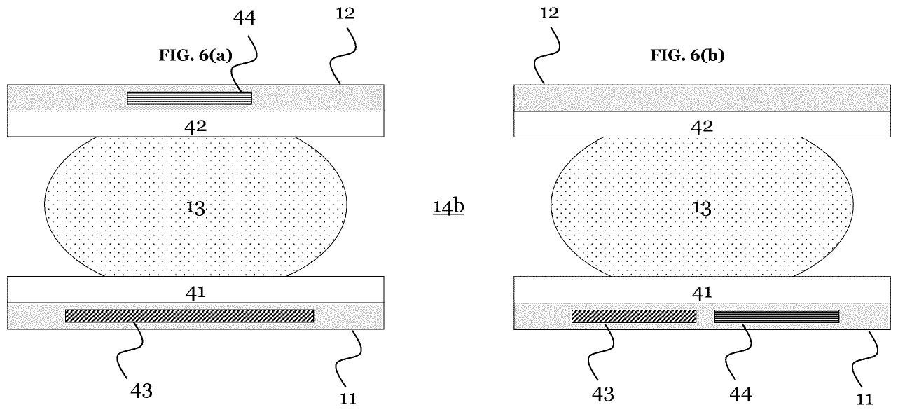

FIG. 6(a) and FIG. 6(b) show that also an in-cell configuration of the third sub-zone 14c is possible in a functional zone 14 of the fluid-processing device 10. In this case, in the third sub-zone 14c, a light emitting device 44 and a photodetector 43 may be respectively embedded in the first plate-like structure 11 and/or in the second plate-like structure 12.

FIG. 6(a) shows particularly a so-called “across configuration” of the in-cell configuration of the third sub-zone 14c, wherein the integrated light emitting device 44 is arranged, for example, in the second plate-like structure 12, while the integrated photodetector 43 is arranged in the first plate-like structure 11. In some example embodiments, the integrated light emitting device 44 may be arranged in the first plate-like structure 11, and the integrated photodetector may be arranged in the second plate-like structure 12. Each plate-like structure 11 and/or 12 may also comprise an integrated optical filter 42, which may isolate certain light and/or may filter out unwanted wavelengths.

FIG. 6(b) shows a “same-side configuration” of the in-cell configuration of the third sub-zone 14c, wherein both the integrated light emitting device 44 and the integrated photodetector 43 are arranged in the same plate-like structure, for example, in the first plate-like structure 11 as shown. In some example embodiments, the integrated light emitting device 44 and the integrated photodetector 43 may be arranged in the other plate-like structure 12. Each plate-like structure 11 and 12 may again comprise an integrated optical filter 42, which may isolate light and/or may filter out unwanted wavelengths.

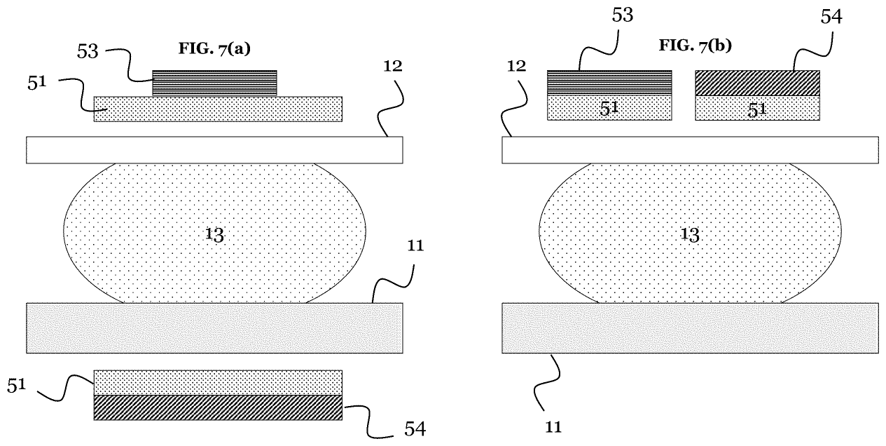

FIG. 7(a) and FIG. 7(b) show an example of the add-on configuration of the third sub-zone 14c, which may be used in the plate-like structure 30 of FIG. 4 or FIG. 5. In FIGS. 7(a) and 7(b) the second plate-like structure 12, and optionally also the first plate-like structure 11, are transparent to light 17 of at least one predetermined wavelength. A light emitting device 53 and a photodetector 54 are further respectively arranged on or besides an outer surface of the first plate-like structure 11 or of the second plate-like structure 12. The light emitting device 53 is configured to emit the light 17 of the at least one predetermined wavelength, and the photodetector 54 is configured to detect the light 17.

FIG. 7(a) shows an across configuration of the add-on configuration of the third sub-zone 14c, wherein the light emitting device 53 and the photodetector 54 are arranged on or besides different plate-like structures 11 and 12. For example, the light emitting device 53 is arranged on or besides the second plate-like structure 12 with an optical filter 51 arranged in between the plate-like structure 12 and the light emitting device 53 and the photodetector 54 arranged on or besides the first plate-like structure 11. In some example embodiments, the first plate-like structure 11 may also have an optical filter 51 arranged in between the first plate-like structure 11 and the photodetector 54. The second plate-like structure 12 may be a glass that may be coated with a transparent oxide, and the first plate-like structure 11 may be a transparent TFT backplane or a transparent region of a TFT backplane.

FIG. 7(b) shows a same-side configuration of the add-on configuration of the third sub-zone 14c, wherein the light emitting device 53 and the photodetector 54 are arranged on or beside the same plate-like structure 11 and 12. In the example embodiment shown in FIG. 7(b), the light emitting device 53 and the photodetector 54 are arranged on or beside the second plate-like structure 12. Optical filters 51 may be arranged between the second plate-like structure 12 and, respectively, the photodetector 54 and the light emitting device 53. Like in FIG. 7(a), the second plate-like structure 12 may be glass that may be coated with transparent oxide. The first plate-like structure 11 may be a (e.g., non-transparent) TFT backplane.

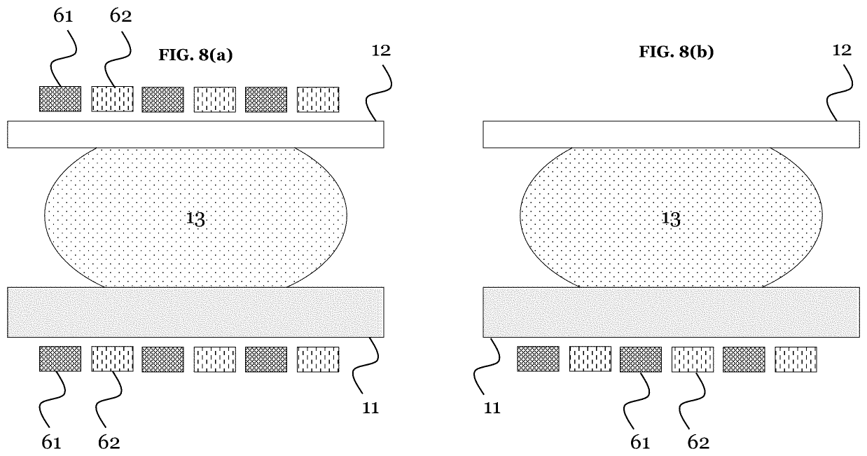

FIG. 8(a) and FIG. 8(b) show an add-on configuration of a sub-zone, which could be the first sub-zone 14a or the second sub-zone 14b, or could be a sub-zone configured to apply the heat 15 and the magnetic field 16. One or more heating elements 61 are respectively arranged on or besides the outer surface of the first plate-like structure 11 and/or of the second plate-like structure 12. Further, one or more magnetic field generating elements 62 are respectively arranged on or besides an outer surface of the first plate-like structure 11 and/or of the second plate-like structure 12.

FIG. 8(a) shows a double-side configuration of the add-on configuration of the sub-zone, wherein the heating elements 61 and the magnetic field generating elements 62 are arranged on or besides both plate-like structures 11 and 12. The first plate-like structure may be a TFT backplane for EWOD, and the second plate-like structure 12 may be a glass that may be coated with a transparent oxide. The heating elements 61 and the magnetic field generating elements 62 may be arranged in an interleaved manner, e.g., arranged in an alternating fashion along at least one direction. The functional elements 61 and 62 may be operated individually, or in sets, or together.

FIG. 8(b) shows a single-side configuration of the add-on configuration of the sub-zone, wherein the heating elements 61 and the magnetic field generating elements 62 are arranged on or beside only one side of the plate-like structures 11 and 12. In the example embodiment shown in FIG. 8(b), for example, the heating elements 61 and the magnetic field generating elements 62 are arranged on or beside the first plate-like structure 11. The first plate-like structure 11 may be a TFT backplane for EWOD, and the second plate-like structure 12 may be a glass that may be coated with a transparent oxide.

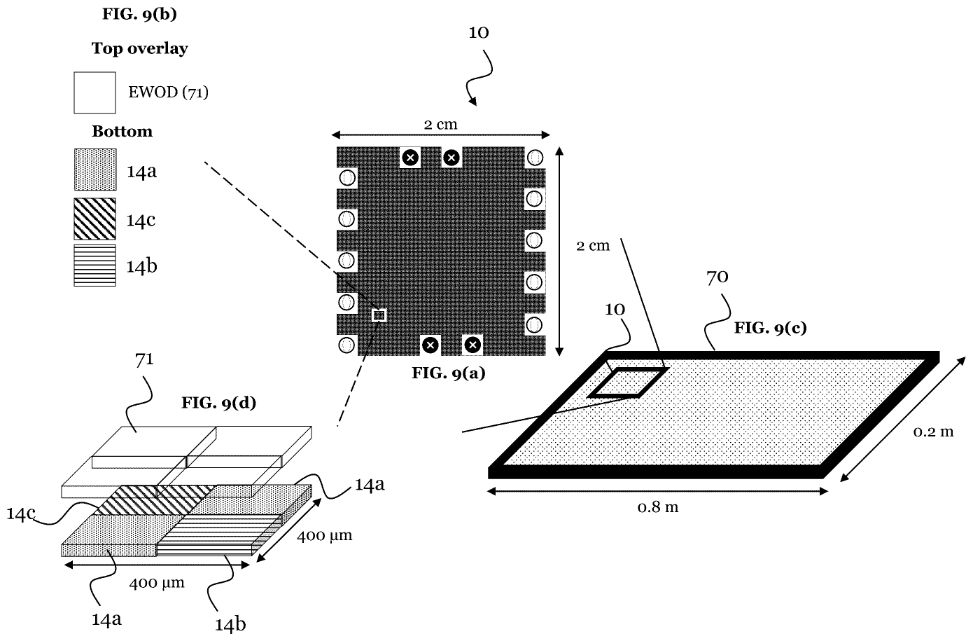

FIG. 9(a), FIG. 9(b), FIG. 9(c), and FIG. 9(d) show a fluid processing device 10 and fluid processing array 70 according to an example embodiment. The fluid processing device 10 and the fluid processing array 70 can be used to implement different droplet processing workflows, particularly, longer and/or atypical workflows for library preparation.

FIG. 9(a) shows the fluid-processing device 10. In this example, the fluid-processing device 10 is a chip, bio chip, or is integrated into a chip or bio chip. The chip comprises the multiple functional zones 14. Each functional zone 14 may be a pixel of the chip. \

The functional zones 14 may all be identical and comprise each a first sub-zone 14a, a second sub-zone 14b, a third sub-zone 14c, and a fourth sub-zone identical to any one of the first sub-zone 14a, second sub-zone 14b, or third sub-zone 14c. FIG. 9(d) shows an example embodiment, according to which each functional zone 14 of the chip comprises two first sub-zones 14a (in other words, the fourth sub-zone is identical to the first sub-zone 14a).

In an example embodiment, the chip may have and area of about 2 cm×2 cm, and may comprise an EWOD on TFT display as the first plate-like structure 11 (e.g., it may be similar to the substrate shown in FIG. 4 or FIG. 5). This chip may be divided into up to 400 individually controllable functional zones 14. The chip may further comprise an overlay 71 for EWOD as the second plate-like structure 12. That is, each functional zone 14 and each sub-zone of the chip is covered with the overlay 71, as illustrated in FIG. 9(d). The first plate-likes structure 11 may be referred to as “bottom”, and the second plate-like structure as “top” overlay (see FIG. 9(b)).

The chip provides a new microfluidic structure, which allows for flexible processing of the one or more droplets 13, and thus flexible implementation of sample library preparation workflows. The term “sample library preparation” can refer to any combination of biochemical reactions, which transform input samples (e.g., nucleic acids) to a configuration that can be read by a sequencer, and is not limited to a specific sequencing chemistry.

The chip may have pixel-level implementation of the four essential functionalities, which can be used to deploy library preparation protocols and workflows. These four functionalities include providing the heat 15 (pixel heat), providing the magnetic field 16 (pixel bead), providing the light (pixel light), and manipulating the droplets 13 (pixel drop). The functionalities may be distributed evenly across the chip, thus allowing for flexibility in programming any library preparation workflow for discrete samples on the chip. Pixel drop utilizes the electrowetting principle (or EWOD) to move, split, combine and mix the droplets 13. Pixel heat may be needed to allow isothermal enzymatic incubation reactions, as well as temperature cycling enabled Polymerase Chain Reaction (PCR). Pixel bead may allow DNA-bound paramagnetic beads to be concentrated, and as such can allow for a buffer exchange as well as up concentration of the bound DNA. Pixel light may allow for tracking of the droplets 13, as well as for colorimetric or fluorometric analysis, for example, for performing quality controls during sample preparation.

FIG. 9(c) shows the fluid processing array 70, which in this case is a panel and comprises a plurality of the fluid processing devices 10. The fluid processing array 70 comprises a plurality of the chips (e.g., in a range of 200-1000 chips, for example, 400 chips), and each chip is one of the fluid processing devices 10 or at least comprises at least one of the fluid processing devices 10. The multiple chips or fluid processing devices 10 can be arranged in rows and/or columns to form the fluid processing array 70, in order to allow for more complex or elaborate sample processing protocols. Parallelization may allow the processing of up to 400 different samples simultaneously.

Input of the one or more droplets 13, e.g. comprising samples and reagents, as well as the output of the prepared library are beneficial for the efficient implementation of assay on the chip or array 70. Two possible approaches are envisioned for providing input ports and output ports. In a first approach, an acoustic-based method may be used. For instance, input ports and/or output ports may comprise one or more PMUTs. This technology would allow the acoustic inter-plate transfer of below microliter reagent volumes. In a second approach, a precise feedback control of a pipette through projected capacitive sensing can allow for contact dispensing of below microliter reagent volumes.

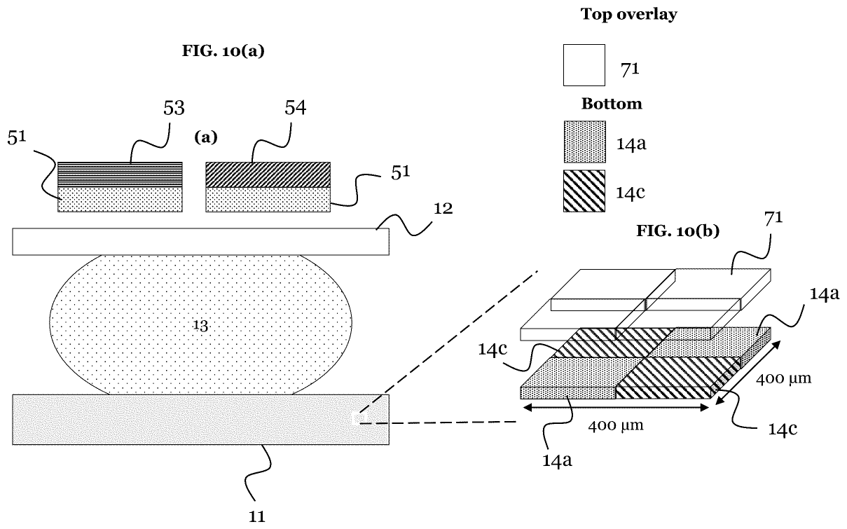

FIG. 10(a) and FIG. 10(b) show an example of a fluid-processing device 10, which may be a chip as shown in FIGS. 9(a)-(d) and may have a similar pixel or unit cell as shown in FIG. 9(d), however, without any third zone 14c. The fluid processing device 10 is shown in same-side configuration, and is similar to the fluid processing device 10 shown in FIG. 7(b). A light emitting device 53 and a photodetector 54 are arranged on or besides the second plate-like structure 12. Optical filters 51 may be arranged between the second plate-like structure 12 and, respectively, the photodetector 54 and the light emitting device 53.

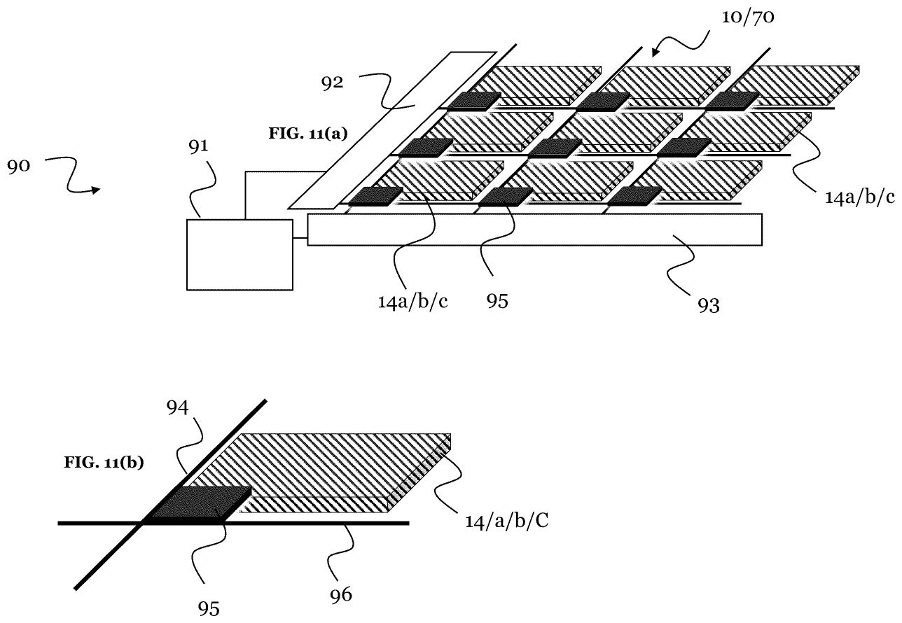

FIG. 11(a) and FIG. 11(b) show an implementation for individually addressing the sub-zones 14a, 14b, and 14c of a fluid processing system 90 according to an example embodiment. The fluid processing system 90 is shown in FIG. 11(a) and comprises at least one fluid processing device 10 or at least one fluid processing array 70, and further comprises a control unit 91, for instance, a microcontroller. FIG. 11(a) shows that the fluid processing device 10 or array 70 has a matrix (columns and rows) arrangement of the sub-zones 14a, 14b, and 14c, and comprises row addressing lines 92 and column addressing lines 93, which are respectively interfaced with the control unit 91. Further, switches 95 are provided, one switch 95 for each of the sub-zones 14a, 14b, and 14c. The control unit 91 may use the addressing lines 92, 93 and the switches 95 to individually address each sub-zone 14a, 14b, and 14c. FIG. 11(b) shows one of the sub-zones 14a, 14b, and 14c in an enlarged view. The sub-zone comprises a gate line 94 that is connected to the column addressing line 93, and comprise a data line 96 that is connected to the row addressing line 92. Each sub-zone 14a, 14b, and 14c may be identically connected by such a gate line 94 and data line 96. The switch 95 may be connected to gate line 94 and data line 96.

In an example embodiment, the control unit 91 can be configured to control an operation of one or more of the sub-zones 14a, 14b, and 14c of the fluid processing device 10 or array 70, so as to apply heat 15, a magnetic field 16, and/or light 17, in any order to one or more droplets 13.

In another example embodiment, the control unit 91 can be configured to control, at the same time, an operation of any two or more functional zones 14 of the fluid processing device 10 or array 70, so as to respectively apply heat 15, a magnetic field 16 and/or light 17, in any order, to one or more first droplets 13 and to one or more second droplets 13, i.e., simultaneously to different droplets 13 potentially in different functional zones 14.

In another example embodiment, the control unit 91 can be configured to control a movement of one or more droplets 13 to one or more functional zones 14 of the fluid processing device 10 or array 70.

In another example embodiment, the control unit 91 can be configured to control a movement of one or more droplets 13 to one or more fluid processing devices 10 of the fluid processing system 90.

In some example embodiments, the control unit 91 may comprise a processor or processing circuitry configured to perform, conduct or initiate the various operations of the control unit 91 described above. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The control unit 91 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the control unit 91 to be performed. In one embodiment, the processing circuitry comprises one or more processors and a non-transitory memory connected to the one or more processors. The non-transitory memory may carry executable program code which, when executed by the one or more processors, causes the control unit 91 to perform, conduct or initiate the operations or methods described herein.

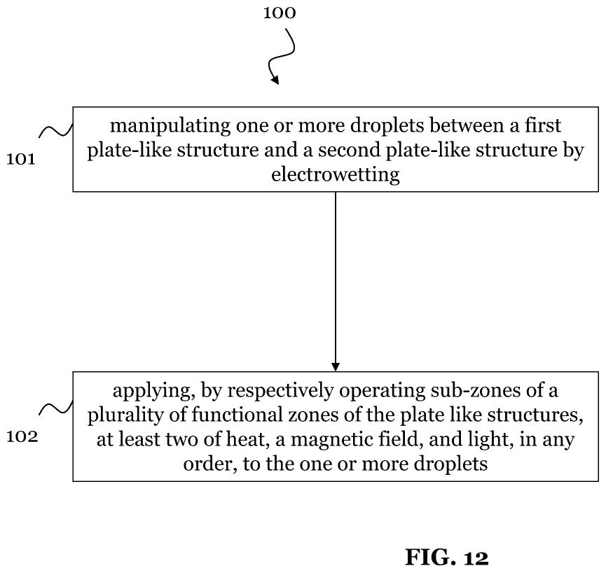

FIG. 12 shows a method 100 according to this disclosure. The method 100 may be used for fluid processing, and can be performed by the fluid processing device 10. The method comprises a step 101 of manipulating one or more droplets 13 of a fluid or liquid, which are located between a first plate-like structure 11 and a second plate-like structure 12, by electrowetting. The method 100 further comprises a step 102 of applying, by respectively operating one or more sub-zones 14a, 14b, and 14c of a plurality of functional zones 14 of the fluid processing device 10, at least two of heat 15, a magnetic field 16, and light 17, in any order, to the one or more droplets 13. The steps 101 and 102 may be performed in any order, and may be performed one or more times.

In some example embodiments, a “Nextera” DNA library preparation workflow could be implemented by the fluid processing device 10 and method 100. At first, a tagmentation step could be performed, whereby a sample (including DNA), a tagmentation enzyme, and a buffer are introduced on the fluid processing device 10 as one or more droplets 13, which may be mixed and heated (with heat 15 in a first sub-zone 14a), which allows the included DNA to fragment and at the same time be tagged in a one-step reaction. Next, a purification step could be performed using magnetic beads (and a magnetic field 16 in a second sub-zone 14b), which allows for a buffer exchange, whereby the tagmented DNA bound on the beads may be later re-suspended. PCR reagents could be subsequently introduced on the fluid processing device 10, and may be mixed with the re-suspended DNA, after which temperature cycling may be performed (using heat 15 in a first sub-zone 14a) to allow adaptor ligation and library amplification. Another bead-based purification step (with a magnetic field 16 in a second sub-zone 14b) may allow the used PCR reagents to be washed away from the amplified library DNA and re-suspended to the desired concentration in a sequencer-compatible buffer.

In the following claims as well as in the description of this disclosure, the word “comprising” does not exclude other elements or steps and the indefinite article “a” or “an” does not exclude a plurality. A single element may fulfill the functions of several entities or items recited in the claims. The mere fact that certain measures are recited in the mutual different dependent claims does not indicate that a combination of these measures cannot be used in an alternative implementation.

What is claimed is:

1. A fluid processing device comprising:
a first plate-like structure and a second plate-like structure configured to manipulate one or more droplets, which are located between the first and the second plate-like structure, by electrowetting; and
a plurality of functional zones, wherein each functional zone comprises at least two of:
a first sub-zone for applying heat to the one or more droplets;
a second sub-zone for applying a magnetic field to the one or more droplets; and
a third sub-zone for providing light onto and/or detecting light emitted by the one or more droplets.

2. The fluid processing device according to claim 1, wherein
each sub-zone has an area in a range of 1e⁻⁶ cm² to 1 cm² or in a range of 5e⁻⁵ cm² to 5e⁻⁴ cm²; or
the functional zones are identical.

3. The fluid processing device according to claim 1, wherein in the second sub-zone, a metal coil is embedded in the first plate-like structure or in the second plate-like structure, the metal coil being configured to generate a magnetic field.

4. The fluid processing device according to claim 1, wherein in the second sub-zone, a permanent magnet is embedded in the first plate-like structure or in the second plate-like structure, the permanent magnet being configured to generate a magnetic field.

5. The fluid processing device according to claim 1, wherein in the first sub-zone, a micro-heater is embedded in the first plate-like structure or in the second plate-like structure.

6. The fluid processing device according to claim 1, wherein:
in the second sub-zone, one or more magnetic field generating elements are respectively arranged on or besides an outer surface of the first plate-like structure or of the second plate-like structure; or
in the first sub-zone, one or more heating elements are respectively arranged on or besides the outer surface of the first plate-like structure or the outer surface of the second plate-like structure.

7. The fluid processing device according to claim 1, wherein in the third sub-zone, a light emitting device and a photodetector are respectively embedded in the first plate-like structure or in the second plate-like structure.

8. The fluid processing device according to claim 1, wherein in the third sub-zone:
the first plate-like structure or the second plate-like structure is transparent to light of at least one predetermined wavelength; and
a light emitting device, which is configured to emit the light of the at least one predetermined wavelength, and a photodetector are respectively arranged on or besides an outer surface of the first plate-like structure or of the second plate-like structure.

9. The fluid processing device according to claim 1, wherein at least one of the functional zones comprises the first sub-zone, the second sub-zone, and the third sub-zone, and comprises a fourth sub-zone, which is identical to either the first sub-zone, the second sub-zone, or the third sub-zone.

10. The fluid processing device according to claim 1, further comprising:
one or more magnets arranged next to the first plate-like structure or the second plate-like structure, and configured to generate a magnetic field that penetrates the one or more droplets when they are located between the first and the second plate-like structure; or
a thermal interface arranged next to the first plate-like structure or the second plate-like structure, and configured to provide a predetermined temperature across at least the first plate-like structure and the second plate-like structure.

11. The fluid processing device according to claim 1, further comprising:
one or more input ports, each input port being configured to receive the one or more droplets and to provide the one or more droplets to between the first plate-like structure and the second plate-like structure; or
one or more output ports, each output port being configured to eject the one or more droplets from between the first plate-like structure and the second plate-like structure or from the fluid processing device.

12. A fluid processing array comprising a plurality of fluid processing devices according to claim 1.

13. The fluid processing array according to claim 12, wherein:
the fluid processing array is a chip or a panel; or
the fluid processing array comprises a plurality of chips, each chip comprising at least one of the fluid processing devices.

14. The fluid processing array according to claim 12, wherein the fluid processing array further comprises:
one or more control units configured to address and control individually each sub-zone of each functional zone in each fluid processing device in the fluid processing array.

15. A fluid processing system comprising at least one fluid processing device according to claim 1, wherein the fluid processing system further comprises:
a control unit configured to address and control individually each sub-zone of each functional zone in the fluid processing system.

16. The fluid processing system according to claim 15, wherein the control unit is configured to:
control an operation of one or more sub-zones of any functional zone of the fluid processing device or of a fluid processing array, so as to apply heat, a magnetic field or light, in any order, to one or more droplets; or
control at the same time an operation of any two or more functional zones of the fluid processing device or of the fluid processing array, so as to respectively apply heat, a magnetic field or light, in any order, to one or more first droplets and to one or more second droplets.

17. The fluid processing system according to claim 15, wherein the control unit is further configured to:
control a movement of one or more droplets to one or more functional zones of the fluid processing device or of the fluid processing array; or
control a movement of one or more droplets to one or more fluid processing devices of the fluid processing system.

18. A method of manipulating droplets, the method comprising:
manipulating one or more droplets between a first plate-like structure and a second plate-like structure by electrowetting; and
applying, by respectively operating sub-zones of a plurality of functional zones of the plate-like structures, at least two of heat, a magnetic field, and light to the one or more droplets.

19. The method of claim 18, wherein the method further comprises:
purifying by one or more magnetic beads disposed within at least one of the sub-zones of the plurality of functional zones of the plate-like structures, the one or more droplets.

20. The method of claim 18, wherein the one or more droplets comprise a sample of deoxyribonucleic acid (DNA).
